(19) United States
(12) Patent Application Publication
(10) Pub. No.: US 2025/0060065 A1
(43) Pub. Date: Feb. 20, 2025

(54) INSPECTION ROBOT

(71) Applicant: BAHMAN ROBOTICS LTD, Edinburgh (GB)

(72) Inventor: Amim RIGI, London (GB)

(21) Appl. No.: 18/791,382

(22) Filed: Jul. 31, 2024

Related U.S. Application Data
(63) Continuation of application No. 17/635,340, filed on Feb. 14, 2022, now abandoned.

(30) Foreign Application Priority Data
Aug. 14, 2019 (GB) 1911649.0

(51) Int. Cl. F16L 55/48; F16L 55/32; F16L 101/30

(52) U.S. Cl. CPC F16L 55/48; F16L 55/32; F16L 2101/30

(57) ABSTRACT

An aquatic in-pipe inspection robot is provided and comprises: means for determining the position of the robot within a pipe and means for adjusting the position of the robot within the pipe, whereby contact with the pipe wall can be avoided; and sensor means for inspecting a pipe.

The present invention relates generally to an inspection device and particularly, although not exclusively, to a robot for inspecting conduits, pipes and the like, for example an in-pipe inspection robot.

Pipelines have been used for many hundreds of years to transport resources from one location to another. Pipeline inspection is a part of pipeline integrity management for keeping the pipeline in good condition.

The present invention seeks to provide improvements in or relating to the inspection of pipes.

An aspect of the present invention provides an aquatic in-pipe inspection robot comprising: means for determining the position of the robot within a pipe and means for adjusting the position of the robot within the pipe whereby contact with the pipe wall can be avoided; and sensor means for inspecting a pipe.

The principle of some embodiments is the ability to move along a water pipe in which water is present without touching the side of the pipe (which in the case of a water pipe could dislodge unwanted material into the water supply).

In some aspects and embodiments the unique features of the device make it possible to conduct inspections in live pipes which reduces time and cost required for the inspections, furthermore, increasing the satisfaction of customers (e.g. water companies).

The robot may comprise collision avoidance means. This could be, for example, a feedback system for assessing the position of the robot and/or distance/s from the pipe wall, then reacting to cause the robot to move e.g. to a predefined position (e.g. the centre axis of the pipe), to a predefined distance/to maintain a predefine minimum distance. Some embodiments, for example, have one or more arrays of sensors (e.g. ultrasound and/or laser) to measure the distance of the robot from some/any points of the wall.

Some embodiments comprise means for interacting with the fluid in the pipe to steer the robot e.g. thrust means/fins/flaps or the like.

Some embodiments comprise means for navigating and/or maneuvering the robot through and/or within the pipe.

The robot may comprise an inertial navigation system.

The robot may comprise one or more motors for controlling movement through and/or within the pipe. Some embodiments comprise two or four motors, for example.

Some embodiments comprise motor speed control.

Some embodiments comprise one or more flaps for controlling cross sectional and/or longitudinal position within the pipe.

The sensor means may comprise one or more of: hydrophone, sound, pressure, temperature; means for measuring water density; means for assessing water quality; ultrasound imaging.

In some embodiments the robot can stay submerged at a specific depth.

Some embodiments comprise a ballast tank which can be used, for example, to help control/adjust depth.

The robot may be capable of omnidirectional 3D movement. Some embodiments, for example, can rotate around their central axis.

The robot may comprise location means for identifying and/or monitoring the location of the robot in a pipe.

Some embodiments comprise means for moving without (forward) thrust.

A further aspect provided an inspection robot for inspecting live water pipes.

Robots formed in accordance with aspects and embodiments of the present invention may be formed from food approved and/or drinking water approved materials.

In some embodiments the robot is mounted or mountable on a wheeled platform for moving in empty pipes.

Some embodiments comprise autonomous obstacle avoidance means.

The robot may, for example make it possible to conduct frequent inspections in high-risk pipes, thus preventing pipe failure and pipes bursting. The device makes long-range inspections possible (several kilometres) and can be retrieved from same point or another end of the pipe. The product offers a user-friendly realistic 3D interface to monitor the results. The software provides a visual tool that makes it possible to move through the pipe and inspect the pipes as if the robot is moving through the pipe. These results can be compared with future inspections of the same pipe highlighting sudden changes of erosion and corrosion.

In some embodiments the proposed solution is a robot that can move through the trunk mains, for example, whilst they are “live” (with water pressure) and inspect the pipes using a variety of sensors. Such robots and/or other embodiments may alternatively or additionally be able to survey none live pipes and/or empty pipes.

The robot may use high frequency phased array ultrasound sensors for inspecting stress corrosion cracking, fatigue cracks, inclusions, erosion, and internal and external graphitic corrosion.

The ultrasound sensor array can work at frequencies between, for example, IHz-40 MHZ thus making it possible to achieve cm, mm and sub-mm resolutions.

Different frequencies may also be used in swiping mode for extracting information from the pipe.

The ultrasound sensor arrays may have elements that work at different frequencies that range from, for example, IHz-40 MHz, making it possible to pick up large changes to very small e.g. micrometer resolutions. Different frequencies may be used for extracting a range of information from the pipe. Very low frequencies can be used to pick up vibrations (e.g. sound) from pipe leaks.

Whereas lower frequencies will penetrate further in the depth of the pipe but with the lower quality images compared to high-frequency imaging which provided high-resolution images but with less depth penetration. The device may also provide accurate information on the pipe wall thickness.

To identify and minimise measurement errors, a high accuracy laser system may be used in fusion with an Inertial Measurement Unit (IMU) measuring the robot's distance to the inner walls and tracking any robot movements.

The product may use regulated material and can provide further safety by solidifying the device which will remove most of the air in the system, thus removing the possibility of leakage/damage over time. In a worst-case scenario, if the robot fails, it will not affect the water quality even in long periods of time (several years).

A tether can be attached to the robot for safe retrieval of the device if required.

The robot may use any number of motors, for example two or four motors, for its movements through the pipe.

Stability is achieved through flap position control and motor speed control.

The robot can move in all directions and can easily move through bends.

A high accuracy Inertial Navigation Systems (INS) may be provided for tracking the position of the robot in the pipe. The error of such a system could be in the range of a few cm's in one hundred metres.

To further enhance the position accuracy data fusion and image processing may be used. e.g. usage of known distances in the system (this can help reach further accuracy e.g. in the millimeter range).

Other versions of the robot may use two transducers at the two ends of the inspection line for increased accuracy if required. This would enable the robot to be located from the surface too.

A Pipeline Remote Inspection System (PRIS) formed in accordance with the present invention may have a user-friendly realistic 3D interface to monitor the results. The software can provide a visual tool that makes it possible to move through the pipe and inspect the pipes as if the robot is moving through the pipe. These results can be compared with future inspections of the same pipe highlighting sudden changes of erosion and corrosion.

A variety of sensors can be used on the robot to identify position leakage points and also provide additional information about the scale of leakage such as a hydrophone.

Pressure sensors could, for example, be used on the robot to identify position leakage points and also provide additional information about the scale of leakage.

In some embodiments the system can also provide water density information throughout the pipe.

Devices formed in accordance with the present invention may be capable of recording their own position while moving through the pipe and it may also be possible to locate from the surface.

Devices/systems may use a set of methods and materials to not compromise water quality while the robot is being used for inspection. This may include solidifying the whole robot with a biocompatible material, such as polydimethylsiloxane (PDMS) and/or silicon, to remove the air inside the robot. This also reduces the risk of water contamination in case the robot is damaged.

The device may be made from materials that are likely to pass water quality tests, or that can be developed to do so, according to Regulation 31 of The Water Supply (Water Quality) Regulations 2016.

In some embodiments, robots formed in accordance with the present invention make it possible to inspect live water pipes using state of the art technologies.

These technologies include ultrasound, for example high-frequency ultrasound, imaging with millimeter accuracy measurements, within the pipe's walls, laser technologies for erosion measurements inside the pipes and accurate robot positioning within the pipe, and a variety of other sensors such as hydrophone, Sound, pressure, and temperature sensors are used to help find the source of leakage. Low frequency ultrasound can be used to hear the sound of leakages.

The robot may use the Inertial Navigation System (INS) and image processing techniques to map the pipes and provide details information for pinpointing the location of the measurements from above the ground.

The robot can make it possible to conduct frequent inspections in high-risk pipes, thus preventing pipe failure and pipes bursting.

Some embodiments comprise or include a user-friendly realistic 3D interface to monitor the results. The software may provide a visual tool that makes it possible to move through the pipe and inspect the pipes as if the robot is moving through the pipe.

In some embodiments the robot can work with or without a cable attachment.

A cable can, for example, be used to retrieve a robot stuck in the pipe.

A tether can be attached for safe retrieval of the robot it can also be used for data transfer and the power supply.

In some embodiments devices can also navigate and/or transfer data wirelessly.

In some embodiments the device can use Lidar imaging for the wall mapping of the pipes.

The device can use an internal navigation system and also revives additional data from one, two or several transmitters from the two sides of the pipe. This enables high accuracy positioning and mapping within the pipe.

In one embodiment the present invention provides a robot that can move through the trunk mains (large water mains) whilst they are live (filled with water) and inspect the pipes using a verity of sensors.

The robot may use a combination of ultrasound and laser technologies for inspecting stress corrosion cracking, fatigue cracks, inclusions, erosion and internal and external graphitic corrosion.

In some embodiments devices can identify the extent of internal and external graphitic corrosion (depth and shape).

In some embodiments devices can identify for manufacturing defects for example porosity.

In some embodiments devices use foldable propeller arms for size reduction and it can also extend the distance of the sensor from the centre of the device. This is used to improve sensor measurements for different pipe diameters.

In some embodiments the robot is quick, can inspect over longer distances, provide crucial information about the pipes conditions and most importantly can inspect in live pipes.

In some embodiments the robot will stay afloat in the water and use sensor feedback for obstacle avoidance.

In some embodiments the robot can stay submerged at a specific depth. The robot can, for example, use a ballast tank to adjust its density and use sensor feedback for obstacle avoidance.

Some embodiments are designed to allow the robot to travel longer distances than current technologies, and undertake internal 3D mapping of pipes.

Software may provide a visual map of pipes which can be inspected again so users can compare any degradation in the pipes over time.

The device/robot may be a multi-technology system that includes ultrasonic, lasers, sensors, inertial navigating system, in short, we are integrating multiple technologies into a novel product.

Robots formed in accordance with the present invention may monitor the health of pipes.

Sensor technology provided by the present invention can be used as part of an inspection tool/robot/device and/or as a stand-alone product (e.g. an inspection probe) which can be used for both manual and automated pipe inspections.

A probe could, for example, be used as a handheld device. It could also be attached to a handle for inspections. It can both be used for inner and outer sections of the pipe.

A probe may use an Internal Navigation System for mapping the sensors readings and building 3D images of the scans. The ultrasound sensors used can sweep a range of frequency's between IHz-40 MHz both providing in-depth details with lower resolution or scans with less depth but with very high resolutions.

The probes can be installed on robots or products.

The probe may have onboard visual and sound feedback of the ultrasound scans and sensor readouts.

The probe can be wireless and can transmit results in a cloud system or a base station.

Scanning frequency can be adjusted if required for specific scans.

A calibration unit can be used for the sensor calibration and validity before experiments.

The probe may be portable and compact.

The probe can work on battery.

The probe can be used for a range of pipes with different materials such as cast iron, steel, copper, PVC, etc.

A variety of sensor probes can be used for inspections.

A probe can be used for leak detection in the pipes using leak detection methods mentioned above, the probe is waterproof.

The sensor probes can be attached to current inspection systems such as inspection cables.

Robots could use a light or laser source as a transmitter from the input section and use a sensor installed on the robot for both locating the robot in the pipe and high-speed data transmission.

A floatable data transmission system can be used for converting data transmission from air into water. The RF signals transmitted in the air are converted to sound waves and send through the water. This is a transitional device converting signals in the air which have low penetration in water to a format that they can penetrate far distances in water and vice versa.

Receive and transmit nodes can be used for longer distance communications and a floating transmitting and receiving system can be used which floats on the water surface. A part of the module may be outside the water and another part underneath the water which enables the conversion of signals in a way that propagates best in both mediums.

Ultrasound sensors can be used in arrays or single elements and at variety of frequency ranges for pipe health monitoring

Water conditions can be monitored using a variety of sensors e.g. oxygen level and water temperature sensing.

The robot may have electromagnetic connectors that can be used to pick it up if it is stuck in the pipe, for example using a second robot. It may also have gripping mechanisms that can be used by the second robot for the same purpose.

Sonar can also be used for locating the robot in the pipe and data transmission from the base station to the robot and vice versa. Single-photon avalanche diode (SPAD) sensors could, for example, be used for sensing light/laser transmitted from the base station.

Data can be compressed in the device and the compressed data can be transmitted to a based station and decompressed. Frames can also be built and then transferred. Raw data can also be transmitted and then processed in the base station. Inspection data can be stored in the robot and once the inspection has been finished the data can be retrieved from the robot.

The robot may be mounted or mountable on a wheeled platform for moving in empty pipes. The wheeled platform can be wired or wireless.

Water leaks in the UK leave a carbon footprint of 600,000 tons per year. The robot can have a direct effect on reducing carbon emissions due to the reduction of water wasted through leakage thus reducing the electric power required for generating clean water.

The device may be capable of ultrasound imaging using different frequencies.

The device may use laser sensors for erosion measurements inside the pipes and provides accurate robot positioning within the pipe, and a verity of other sensors such as hydrophone, Sound pressure and temperature sensors are used to help find the source of leakage. The robot may use the Inertial Navigation System (INS) and image processing techniques to map the pipes and provide details information for pinpointing the location of the measurements from above the ground.

The device may be capable of high manoeuvres in pipes and can, for example, do 360 rotations in the pipe.

The robot may use an inner water tank for adjusting its overall density so that it is close as possible to that of the water in the pipe.

The robot may use electrical motors for moving vertically and horizontally in pipes.

Sensor measurements (e.g. laser and/or ultrasound) relating to proximity to the pipe wall may be used to influence movement of the robot e.g. feedback from the positional input to give instructions to motors/flap.

In some aspects and embodiments some/all operations of the robot are autonomous, semi-autonomous or manual. Some robots will be provided the options for more than one operation mode. For example, there may be an autonomous mode for moving through a pipe, with collision avoidance means activated to prevent contact with the wall of the pipe. This could, for example set a default of positioning the robot generally along the central axis of the pipe (i.e. around the centre of the cross section). If the robot drifts/moves/is moved away from this then corrective action can be taken. It may be possible for the robot to move closer to a section of pipe (for example by a user in a manual mode), but there may still be anti-collision means active to prevent the robot from moving closer to the pipe wall then a predetermined threshold; this anti-collision means could be operational in any of the modes (even manual).

A further aspect provides a water pipe inspection robot comprising: means for determining the position of the robot within a water pipe and means for adjusting the position of the robot relative to the cross section of the pipe to avoid contact with the pipe wall; and sensor means for inspecting a pipe.

A further aspect provides a method of inspecting a water pipe comprising the steps of: providing an inspection robot; determining the position of the robot within a water pipe; adjusting the position of the robot relative to the cross section of the pipe to avoid contact with the pipe wall; and inspecting a pipe using onboard sensors.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims. Each aspect can be carried out independently of the other aspects or in combination with one or more of the other aspects.

The present invention will now be more particularly described, by way of example, with reference to the accompanying drawings.

Example embodiments are shown and described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate. The robot is not limited in the design and shape of the structure shown in the drawings.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

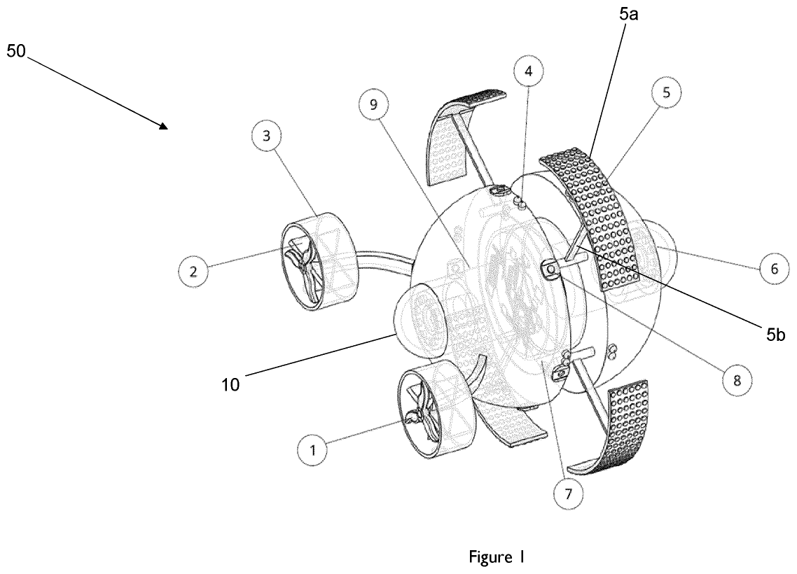

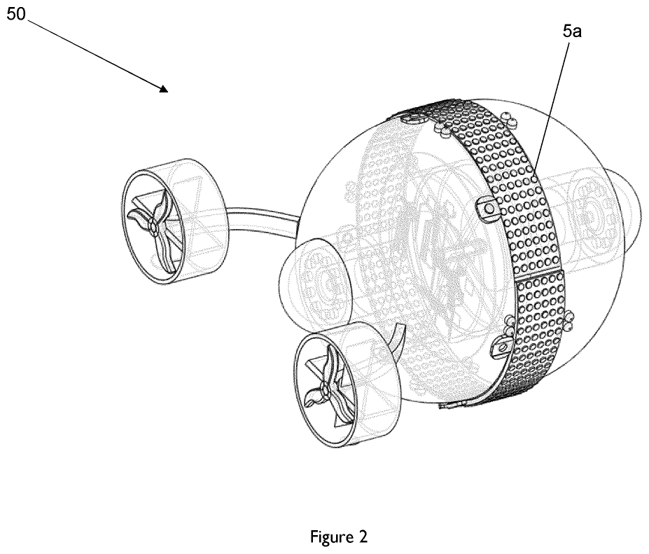

FIGS. 1 and 2 show an in-pipe inspection robot comprising:

1—Motors & Propeller
2—Flaps/control blade
3—Duct, hooking system
4—Sensors ((Pressure, Temperature, Sonde, Hydrophone, PH, etc))
5—Ultrasound array/single element sensors
5a—Ultrasound panel
5b—Array stalk
6—Camera+LIDAR
7—Electronics, actuator control unit, sensor input processing and output, Inertial Navigation System, etc
8—Laser transmitter and receiver
9—Ballast tank
10—Camera

The robot uses an internal inertial navigation system to record its own position and uses low frequency ultrasound for on ground localisation.

The robot uses two motors for its movements through a pipe. Stability is achieved through flap position control and motor speed control. In this embodiment the rotors are positioned in front of the flaps; in other embodiments rotors/propellers/impellers are positioned behind flaps/fins.

The robot can move in all directions and can easily move passed bends. A tether can be attached to the robot for safe retrieval if required.

In this embodiment the robot uses regulated materials. Further safety is provided by preventing the ingress of water, removing the possibility of leakage/damage over time.

A user-friendly 3D interface (not shown) is provided to monitor pipeline integrity. The under-interface provides a visual experience that emulates robot activity during inspections. Inspection data is available in real time and can be uploaded to a cloud server.

Pipe thickness, stress corrosion cracking, fatigue cracks, erosion, internal and external graphitic corrosion and manufacturing defects can be measured/detected. Some embodiments can work in cast iron water mains with a 20-36 inch diameter and a 4 cm wall thickness.

The robot can move through the trunk mains whilst they are live (with water pressure).

The robot movement mechanism makes it possible to move in different directions and can easily pass pends and steep angles.

The robot uses high frequency phased array ultrasound sensors for inspecting the pipes and improves measurements by using laser sensors.

To identify and minimise measurement errors a high accuracy laser system is used in conjunction with an inertial measurement unit (IMU). This data is also used to prevent the robot from colliding with walls.

The ultrasound arrays 5 are provided on arcuate panels 5a which in turn are mounted on stalks 5b. In this embodiment the panels 5 can be moved between extended (FIG. 1) and retracted (FIG. 2) positions. This could be used, for example, to

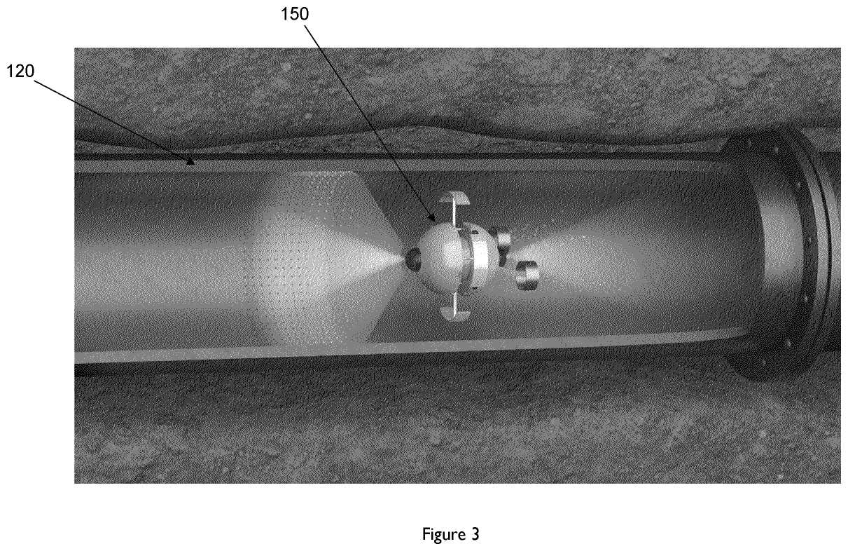

FIG. 3 shows a robot 150 of the type shown in FIGS. 1 and 2 travelling through a live water pipe 120.

In live pipes with water pressure the robot has to control itself and avoid hitting walls because of the forced induced by the water this can be achieved by motor control and flap position control.

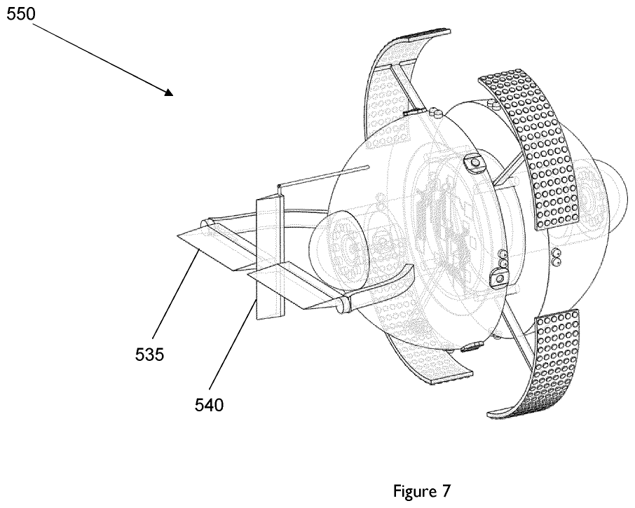

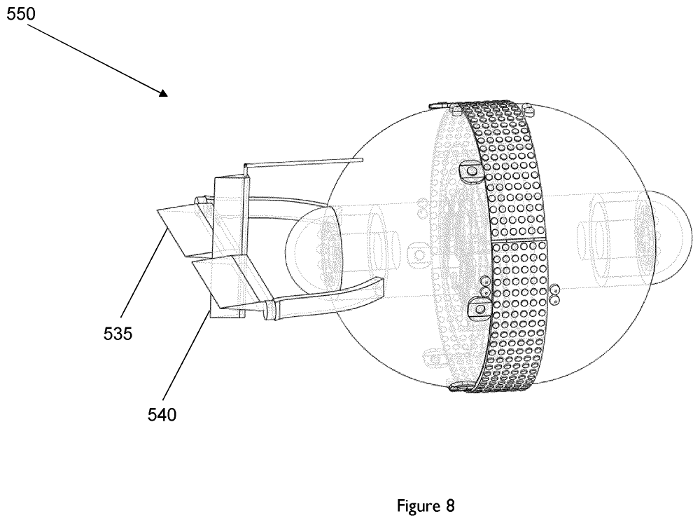

The internal water pressure in the pipe can be used to move the robot forward without motor thrust input from the robot. A self-gliding system has been proposed which enables the robot to work for longer distances (see below in relation to FIGS. 7 and 8).

In live pipes with no water pressure in them the robots thrust (provided through motors) moves the robot through the pipes. Furthermore sensor measurements are used in combination with motor speed control and flap control to move forward and avoid hitting walls.

The device can locate the position of leaks accurately and pinpoint where they are.

The robot can move backwards by rotating the motors in opposite direction. Therefore, the robot can move back to the insertion point (entry) once the inspection is finished.

The robot can work in live pipes (with water pressure), live pipes with no pressure and pipes that are empty of water.

To further enhance the position accuracy data fusion and image processing can be used.

The pipe touch prevention system works using different methods. The position of the robot is estimated using a range of sensor readings from around the robot showing its distance to the inner walls. The data from these sensors are combined to increase measurement accuracy. The sensor data provides accurate data regarding current position of the robot relative to the pipe, this information can then be used to control the robot's movement throughout the pipe. This method can be used in specific regions for example to keep a constant distance from all sides while moving in the pipe.

The proposed robot can work in live pipes (full of water) with water pressure, live pipes without water pressure and empty pipes. Furthermore, the product can be used in other industries such as marine and offshore pipe monitoring (both from inside and outside the pipe), gas pipe monitoring and all other piping systems.

Different sensing methods are used for mapping the pipes some examples include laser, Lidar, optical, ultrasound.

One goal in mapping the pipes is to find small and big variations in the pipes for example identify small changes in the pipes such as early stage corrosions, identify leaks in the system, looking at pipe thickness variation. Mapping will also help monitor the condition of the pipes over time, this can be achieved by overlaying multiple measurements at the same time.

One of the methods that can be used for identifying the position of the robot from above the ground is using a transmit and receive unit which can work with electromagnetic waves or sound waves and will receive signals transmitted from inside the pipe from the robot.

From the surface a transmit and receiver device is used and from inside the pipe the robot transmits a sound, ultrasound or electromagnetic wave which is picked up from the device on the surface.

In case a robot fails in the pipe one method that can be used for rescuing it is using a second robot which can use an electromagnetic hooking system that attaches to the metal duct (3).

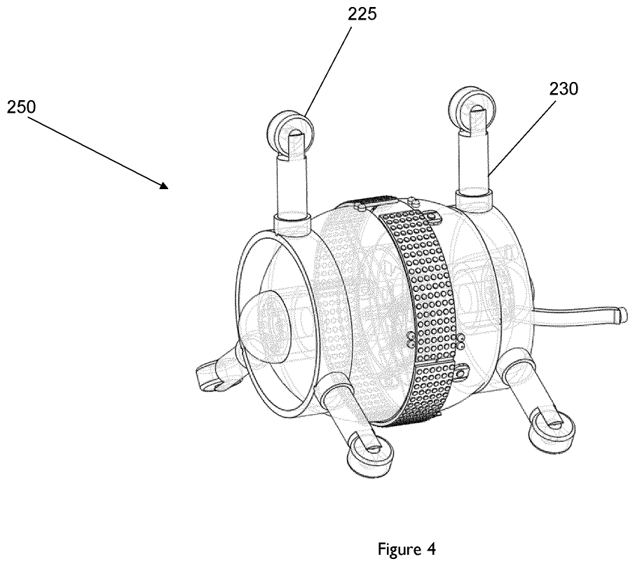

Wheeled structure-FIGS. 4 to 6

In case of empty water pipes or pipes in other industries e.g. gas, the system can be connected to a wheeled structure capable of moving in the robot.

The wheeled structure can have different designs and can function in different ways.

In FIG. 4 the robot has six arms 230 (three at the front and three are the rear, spaced by around |20 degrees) and each carrying a wheel 225.

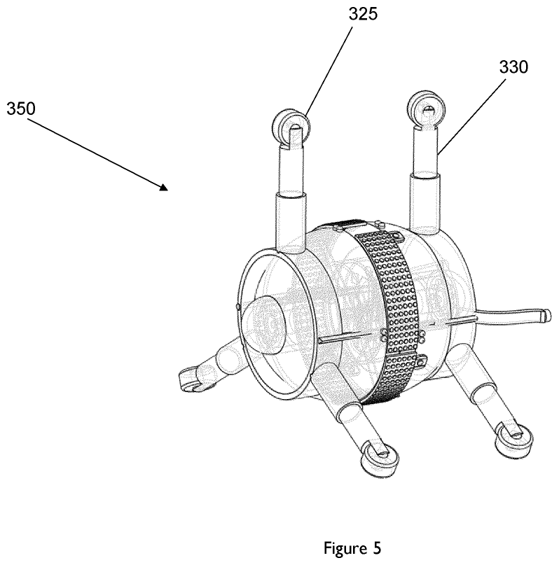

FIG. 5 has a similar arrangement of arms 330 and wheels 325. The arms may, for example, be telescopic.

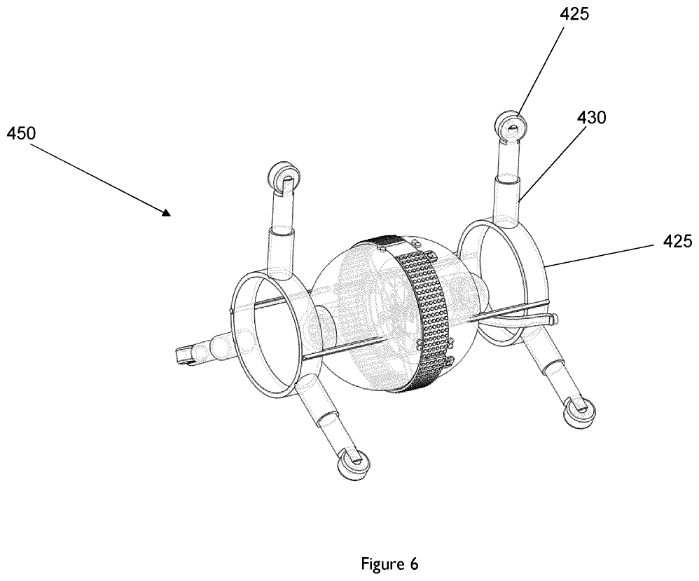

FIG. 6 shows a robot 450 having front and rear carriages 425 that carry wheels 425 carried on arms 430.

Self-gliding/thrustless system—FIGS. 7 and 8

In live water pipes with water pressure, the water pressure in the pipe can be used as the propulsion system to move the robot forward. This method can be used both in the motor system described above (with flaps) to reduce power consumption or as a totally separate manoeuvre system removing the requirement for motors as shown in FIGS. 7 and 8.

This method can work by adjusting the density of the robot so it is very close to that of the water inside of the pipe, making the robot float in a specific depth which can be achieved by using the ballast system (e.g. a ballast tank, not shown) and reading pressure sensor measurements. The robot is then released in the system and using sensor measurements a movable flap system (e.g. “horizontal” 535 and “vertical” 540 arranged in a cross formation) is used to correct the position of the robot to avoid touching pipe wall and enable a stable movement to improve sensor readings. Such a system as a standalone may be more effective compared to having a motor. In a standalone system the flaps could be more stable.

A method of inspecting with such a system would be to insert the robot from one end of the pipe and retrieve the device from another end.

Some embodiments may be provided with both thrust and also thrustless capabilities e.g. motors as well as flaps.

Although illustrative embodiments of the invention have been disclosed in detail herein, with reference to the accompanying drawings, it is understood that the invention is not limited to the precise embodiments shown and that various changes and modifications can be affected therein by one skilled in the art without departing from the scope of the invention as defined by the appended claims and their equivalents.

1-21. (canceled)

22. A live water pipe inspection robot comprising:
a means for determining a position of the robot within a pipe and a movable flap system for adjusting the position of the robot within the pipe whereby contact with the pipe wall can be avoided; and
a sensor means for inspecting a pipe;
wherein the robot is thrustless and water pressure in a live water pipe is used to move it forwards through the pipe and wherein the movable flap system is configured to interact with fluid in the pipe to steer the robot.

23. The robot of claim 22, further comprising a means of collision avoidance.

24. The robot of claim 22, further comprising a means for navigating and/or maneuvering the robot through the pipe.

25. The robot of claim 22, further comprising an inertial navigation system.

26. The robot of claim 22, further comprising one or more motors for controlling movement through and/or within the pipe.

27. The robot of claim 26, further comprising a motor speed control.

28. The robot of claim 22, further comprising one or more flaps for controlling cross sectional and/or longitudinal position within the pipe.

29. The robot of claim 22, wherein the sensor means further comprises: hydrophone, Sonde, pressure, temperature, means for measuring water density, means for assessing water quality, ultrasound imaging, or a combination of two or more of the foregoing.

30. The robot of claim 22, further comprising one or more sensor arrays, wherein the sensors arrays are mounted so as to be movable between extended and retracted positions.

31. The robot of claim 22, further comprising a ballast tank.

32. The robot of claim 22, further comprising a location means of identifying and/or monitoring the location of the robot in a pipe.

33. The robot of claim 22, wherein the robot is formed from food approved and/or drinking water approved materials.

34. The robot of claim 22, wherein the robot is mountable on a wheeled platform for moving in empty pipes.

35. The robot of claim 22, further comprising a means of autonomous obstacle avoidance.

36. The robot of claim 22, further comprising a light or laser source as a transmitter from an input section; and a sensor installed on the robot; wherein the sensor is used for both locating the robot in the pipe and high-speed data transmission.

37. The robot of claim 22, further comprising a floatable data transmission system which can be used for converting data transmission from air into water, wherein RF signals transmitted in the air are converted to sound waves and send through the water.

38. A pipe inspection robot comprising:
a sensor means for inspecting a pipe; and
a wheeled platform on which the robot is mounted or mountable.

39. The robot of claim 38, wherein the robot is wired or wireless.

40. The robot of claim 38, further comprising a thrust system.

41. A method of inspecting a water pipe comprising the steps of:
providing an inspection robot;
determining a position of the robot within the water pipe;
adjusting the position of the robot relative to a cross section of the pipe to avoid contact with a pipe wall; and
inspecting the water pipe using onboard sensors.
